(19) United States
(12) Patent Application Publication
(10) Pub. No.: US 2007/0136493 A1
(43) Pub. Date: Jun. 14, 2007

(54) Systems and methods for using points with a network event

(75) Inventor: Jonathon Linner, San Mateo, CA (US)

Correspondence Address: CARR & FERRELL LLP, 2200 GENG ROAD, PALO ALTO, CA, 94303, US

(73) Assignee: Limbo, Inc.

(21) Appl. No.: 11/602,917

(22) Filed: Nov. 20, 2006

Related U.S. Application Data
(60) Provisional application No. 60/748,900, filed on Dec. 10, 2005.
(60) Provisional application No. 60/748,963, filed on Dec. 10, 2005.
(60) Provisional application No. 60/748,902, filed on Dec. 10, 2005.

(51) Int. Cl. G06F 15/16

(52) U.S. Cl. 709/248

(57) ABSTRACT

A system for using points in a network event includes a communications interface and a processor. The communication interface receives a communication message indicating an entry from a user for a network event. The processor processes the communication message to determine whether to accept the entry for the network event. The processor then accumulates at least one point for the entry into a point total for the user in response to accepting the entry.

### CROSS REFERENCE TO RELATED APPLICATION

The present application claims the priority benefit of U.S. Provisional Patent Application Ser. No. 60/748,900, filed Dec. 10, 2005, entitled “Systems and Methods for Using Points in a Reverse Auction,” U.S. Provisional Patent Application Ser. No. 60/748,963, filed Dec. 10, 2005, entitled “Systems and Methods for Entry into a Networked Event,” and U.S. Provisional Patent Application Ser. No. 60/748,902, filed Dec. 10, 2005, entitled “Systems and Methods for a Networked Event,” which are all hereby incorporated by reference.

The present application is also related to U.S. patent application Ser. No. ______, filed Nov. 20, 2006, entitled “Systems and Methods for Entry into a Network Event,” and U.S. patent application Ser. No. ______, filed Nov. 20, 2006, entitled “Systems and Methods for a Network Event,” which are both herein incorporated by reference.

### BACKGROUND

1. Field of the Invention

The present invention relates generally to network events, and more particularly, to systems and methods for using points with a network event.

### BACKGROUND ART

Consumers will typically try to purchase goods for the lowest possible prices. The expansion of communication networks such as the Internet has resulted in numerous ways to purchase goods ranging from on-line purchases to shopping engines. Recently, some communication devices such as mobile phones and personal digital assistants allow Internet access, which provides further mobility and flexibility in purchasing goods over communication networks.

One example of purchasing goods over the Internet is the traditional auction offered by eBay, Inc. in San Jose, Calif. In this traditional auction, a seller sells their goods using eBay to the highest bidder to maximize the selling price. The auction is open for a period of time or when no higher bids are forthcoming. One limitation is the revenues for the goods are limited to just a highest paid bid even though many bidders may have participated. Besides traditional auctions, another type of auction is a reverse auction, where the goods are sold to the lowest unique bidder.

Besides purchasing goods, another way consumers have obtained goods or prizes is through chance. In one example, a lottery offers goods or cash prizes based on a small chance of winning to participants who have paid some form of payment to enter into the lottery. Lotteries do have the potential for generating large amount of revenues when the revenues from the participants exceed the actual value of the goods or cash prizes. However, one limitation with lotteries is that laws and regulations limit lotteries to be run by certain charitable organizations and state governments. Another limitation is that the entertainment experience for the participant is passive because the winner of the lottery is determined purely by chance without any active participation. There is no sense of competition with other members because the participant does not control their own chances in winning.

In another example, a direct mailing sweepstakes awards goods or prizes based on chance to members who submitted a postcard or entry form but who have not made a purchase or paid an entry fee. The costs of the goods or prizes may be covered from advertising, promotional, or marketing revenues and/or expenses. For example, many companies offer sweepstakes to draw attention to other goods or services offered by the companies. Besides sending in a postcard, the direct mailing sweepstakes has passive participation just as in lotteries, where the lucky winner is determined purely by chance. The chances of winning a sweepstakes or lotteries can be miniscule and may depend on the number of participants. The miniscule chances of winning combined with the passive participation discourage many people from participating in direct mailing sweepstakes and lotteries.

### SUMMARY OF THE INVENTION

Embodiments of the invention address some of the above limitations by providing systems and methods for using points in a network event. A system for using points in a network event includes a communications interface and a processor. The communication interface receives a message indicating an entry from a user for a network event. The processor processes the message to determine whether to accept the entry for the network event. The processor then accumulates at least one point for the entry into a point total for the user in response to accepting the entry.

The network event may be a contest, game, or sweepstakes, such as a reverse auction. The processor may redeem at least some of the point total for a product, a service, or a discount at the direction of the user. The processor may exchange at least some of the point total for value of a loyalty program at the direction of the user. The processor may also receive payment from the user and add additional points to the point total based on the payment. The processor may also forfeit the point total after a period of user inactivity.

Advantageously, the points can be used to develop loyalty to the event provider and to increase motivation for a user to submit more entries into the network event. Since the points can be redeemed into rewards, such as products or travel certificates, the points encourage repeat behavior of the users to accumulate more points by playing more. Furthermore, the points return some value to the user submitting the entry regardless of whether the entry wins in the network event. In some embodiments, a value of at least one point is greater to or equal than a cost to enter into the network event (e.g., submit an entry.)

A method for using points in a network event comprises receiving a message indicating an entry associated with the network event from a user, processing the message to determine whether to accept the entry for the network event, and accumulating at least one point for the entry into a point total for the user in response to accepting the entry.

A software product for using points in a network event comprises server software operational when executed by a processor to direct the processor to receive a message indicating an entry from a user for the network event, process the message to determine whether to accept the entry for the network event, and accumulate at least one point for the entry into a point total for the user in response to accepting the entry, and a storage medium configured to store the server software.

### BRIEF DESCRIPTION OF THE DRAWINGS

FIG. 1 is an illustration of an exemplary architecture for participating in a network event.

FIG. 2 is an illustration of how a user participates in a reverse auction in an exemplary implementation of the invention.

FIG. 3 is an illustration of exemplary messages transmitted to a cellular phone of a user participating in a reverse auction in an exemplary implementation of the invention.

FIG. 4 is a flowchart for conducting a reverse auction in an exemplary implementation of the invention.

FIG. 5 is a flowchart for concluding a reverse auction in an exemplary implementation of the invention.

FIG. 6 is a flowchart for using points in an exemplary implementation of the invention.

FIG. 7 is a flowchart for redeeming and obtaining points in an exemplary implementation of the invention.

FIG. 8 is a block diagram of the event server in an exemplary implementation of the invention.

### DETAILED DESCRIPTION OF THE EMBODIMENTS

The embodiments discussed herein are illustrative of the present invention. As these embodiments of the present invention are described with reference to illustrations, various modifications or adaptations of the methods and/or specific structures described may become apparent to those skilled in the art. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

A network event is an event whereby users may access the event via various networks such as the Internet, public switched telephone networks (PSTN), and wireless networks. In one embodiment, the network event comprises a contest, game, or sweepstakes, such as a reverse auction for a product including a good or service. A reverse auction is an event which is set up in the style of an auction, whereby the product will be awarded to the user that has the lowest unique entry or bid. The lowest unique bid is the lowest bid for the product that has not been selected by one or more other users.

For example, a reverse auction may receive the following bids from one or more users:

Bid 1: $1.22;

Bid 2: $1.22;

Bid 3: $1.23;

Bid 4: $1.23;

Bid 5: $1.24;

Bid 6: $1.25;

Bid 7: $1.25; and

Bid 8: $1.26.

In this example, Bids 1 and 2, which comprise bids of $1.22, are lower than the other six bids. Even though Bids 1 and 2 are the lowest bids, however, neither is unique. The next lowest bids are Bids 3 and 4. Like Bids 1 and 2, Bids 3 and 4 are equal to each other, and are, therefore, not unique. Bid 5, which comprises a bid of $1.24, is both unique and is lower than any other unique bid. Therefore, Bid 5 is the lowest unique bid.

In some embodiments, the user that has the lowest unique bid can win the prize outright, purchase the prize at the price that is the lowest unique bid, purchase the prize in exchange for points, or purchase the prize at a different price (e.g., discounted price).

Individual reverse auctions may require bids to be made in a particular currency (e.g., US dollars or Euros). In other embodiments, specific reverse auctions may allow bids to be made in two or more different currencies. Bids within a reverse auction are not limited to currency. In one example, users may bid points or any other countable units.

If the successful user is unable to obtain the prize (i.e., lack of funds), a user with the next lowest unique bid may be offered the opportunity to purchase or win the prize. This process continues until the user with the next lowest unique bid purchases or wins the prize. If there are no lowest unique bids left, a sponsor can choose the winner randomly from all eligible entries received. In exemplary embodiments, the sponsor is any entity that is associated with the administration of the prize and/or the reverse auction.

In addition to the main prize or product, other prizes, products, or points may be awarded in a game for activities other than the lowest unique entry or bid. For example, prizes, products, or points may be awarded for playing a lucky number, being the Nth entry, being the Nth player, being the Nth new member or player, or collecting N reward points.

In some embodiments, the network event is a game wherein a winner is a user that submits the highest unique entry without going over a given value. In one example, users can submit entries containing the highest unique value without going over $1,000. One user may submit an entry for $999. If a second user also submits a play for $999, then neither entry is unique. As a result, the winning entry is the closest unique entry to $999.

In other embodiments, the network event is a game wherein the winner is a user that submits the closest unique entry to a given value. In one example, users can submit entries above or below the given value. The closest unique entry may be the winning entry. If there are two closest unique entries (e.g., one entry is less than the given value and the other entry is more than the given value), then multiple prizes may be awarded.

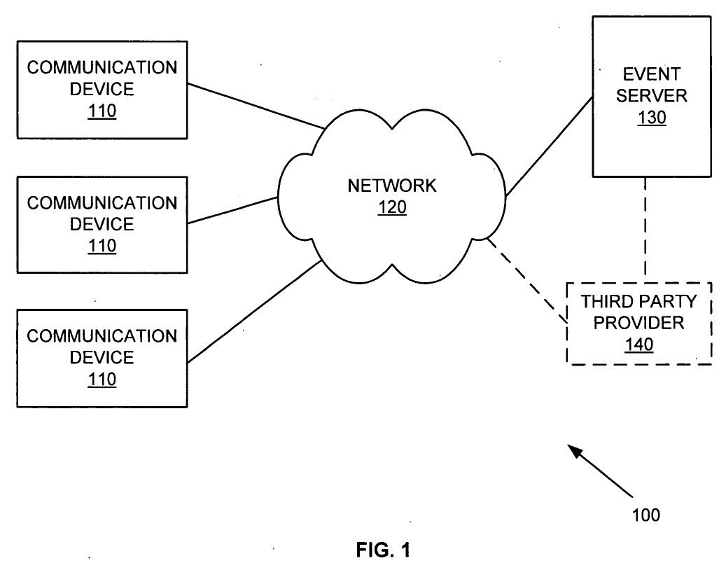

FIG. 1 is an illustration of an exemplary architecture 100 for participating in a network event. The architecture 100 comprises a plurality of communication devices 110 coupled via a network 120 to an event server 130. The communication devices 110 allow users to provide entries, such as bids, and other data to the event server 130. Additionally, the communication devices 110, in some embodiments, are enabled to receive communications from the event server 130.

In various embodiments, the communication device 110 comprises any device which allows for data and/or voice entry and transmission over the network 120. Examples of such communication devices 110 include, but are not limited to, cellular phones, computing devices, telephones, and interactive televisions. Any number of communication devices 110 may be coupled to the event server 130. The communication devices 110 may be coupled to the network 120 via wireless links or communications even though there is no physical coupling.

The network 120 may comprise one or more communication networks, each communication network corresponding to a type of communication device 110. For example, in an embodiment wherein the communication device 110 is a cellular phone, the network 120 comprises a wireless network, while a computing communication device (e.g., a laptop, PDA) will be coupled to the Internet. Alternatively, if the communication device 110 is a telephone, the network 120 may comprise a public switched telephone network (PSTN), and an interactive television may be coupled via a cable or satellite network 120.

The event server 130 is a device configured to establish and conduct a network event such as a reverse auction. In exemplary embodiments, the event server 130 is a computing device comprising, or coupled to, one or more databases containing item/prize information, user information, and any other information necessary for conducting the network event. The exemplary event server 130 may also comprise a communication interface for receiving and transmitting communications (e.g., bids, status messages, user ID, etc.) from and to the communication devices 110 and a processor for processing bids and verifying user and bid information. Further components may be included in the event server 130 depending on the nature of the event.

Entries, bids, and other data may be provided to the event server 130 in a manner supported by each type of communication device 110. With regard to the cellular phone communication device 110, entries are made by short message service (SMS) messaging according to one embodiment. The user submits a SMS entry by sending a text message from the cellular phone to a designated number/code. To place an entry or bid, the user texts an amount without punctuation. For example if the entry is $1.27, the user texts “127” to the designated number/code. The designated number/code provides the mechanism to couple the communication device to the event server 130. In a further embodiment, messaging may be conducted via multimedia messaging service (MMS) or other means of messaging and communication with wireless communication devices.

In an embodiment where the user utilizes the telephone to submit an entry or bid, the user calls a designated number. Once connected via the designated number, the user may enter their entry or bid using the numeric buttons on the telephone without punctuation when prompted. In this embodiment, the information is transferred via dual tone multi frequency (DTMF). Alternatively, the user may provide the entry or bid by speaking the play or bid when prompted.

With regard to Internet entries or bidding, the user will go to the event server 130 website. In one embodiment, the website provides a “play now” or “bid now” feature which provide fields for the user to enter. The fields may include game identifier, auction item identifier, entry amount, and/or user identifier. In another embodiment, the user may just e-mail an entry or bid for a game to the event server 130.

The user may access a particular event and submit the entry (e.g., bid on a particular item in a reverse auction) via various embodiments. In one embodiment, the user may bid on a particular item by calling or text messaging a designated number/code corresponding to the particular item to the event server 130. For example, a user can bid on a Sony PSP by text messaging “PSPBID” to the event server 130.

Alternatively, the user may call one general designated number and follow prompts to access the particular game or item the user is interested in playing or bidding on. For example, an interactive voice recording (IVR) may play that prompts the user to press “1” if the user want to play for the Mini Cooper, press “2” if the user want to play for the iPod, and so forth.

In a further example, the interactive voice recording allows the user to speak terms or provide corresponding entries (e.g., press the corresponding button) that will conduct a search for particular games or items. For instance, a first prompt may ask the user to respond with a category of items they are interested in (e.g., automobile, electronics). The response takes the user to the next level of the IVR where another prompt may be given to narrow the selected category (e.g., brand name for an automobile, MP3 player for electronics). The prompts continue until a particular game or item is found.

For the Internet enabled communication devices 110 (e.g., laptops, PDA, and some cellular phones), the user may search for a particular game or item. In one embodiment, a search engine is provided wherein the user enters a game name/identifier, product name, description, and/or keywords of games or products they desire to play or bid on. The search engine then returns results for the user to review and select from. Alternatively, the user may scroll through web pages listing particular items to bid on or select from narrowing category web pages to arrive at a particular game or item. Interactive television communication devices 110 may operate in a similar manner.

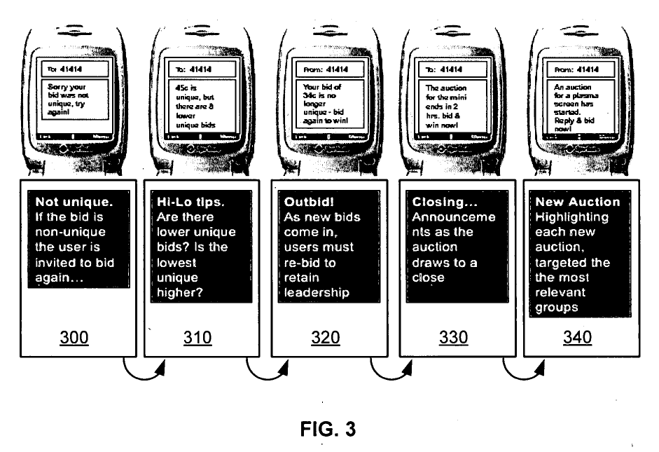

Once an entry, bid, or other data is provided to the event server 130, the event server 130 may provide corresponding responses. As discussed above, the event server 130 may forward search results or narrowed categories for searches for particular items. The event server 130 also provides status and/or updates of the game and the user's entry in relations to the game. These status responses will be discussed in more detail in connection with FIG. 3.

In some embodiments, a single user may communicate with the event server 130 via one communication device 110 and receive status and/or update responses from the event server 130 via a different communication device 110. For example, a user may send an entry to the event server 130 via their cellular phone but request that responses be sent to their e-mail account. It should be noted that any number of different types of communication devices 110 can provide entries to the event server 130.

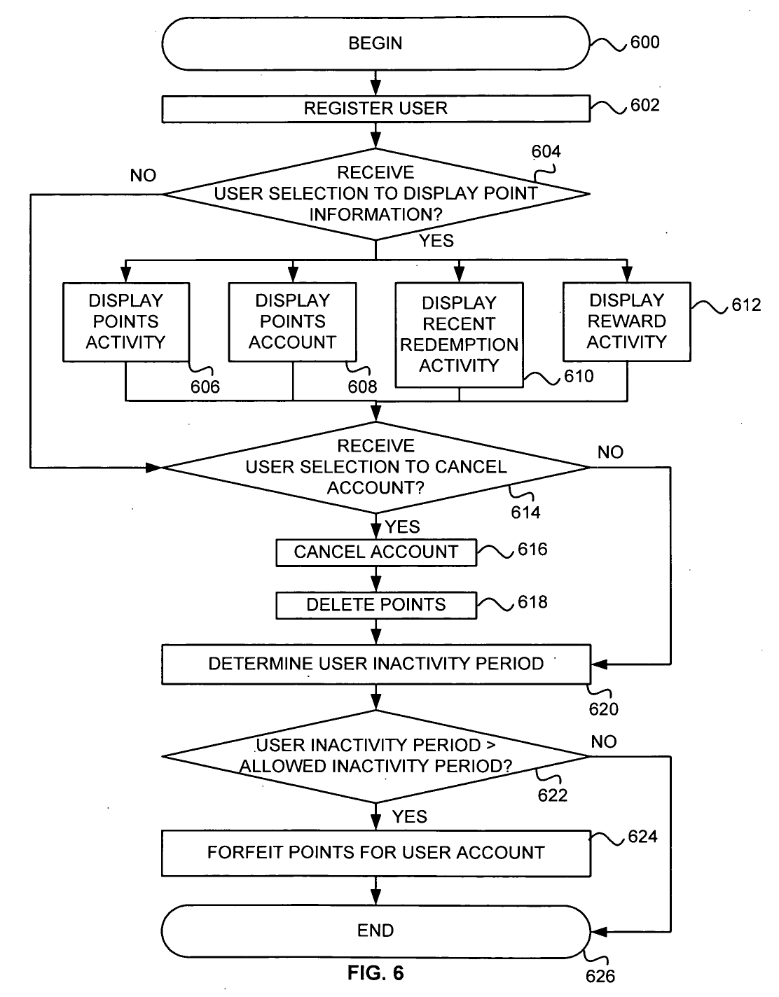

Utilizing these methods of entry, the user is charged a fee for each entry from their communication device 110. In the embodiment of the cellular phone and telephone, the charges may be automatically added to their phone bill (e.g., via reverse sms). Similarly, charges for interactive television use may be automatically added to their television bill. A free method of entry may also be provided, which will be discussed in more detail in connection with FIG. 6.

In a further embodiment, one or more third party providers 140 may be coupled to the network 120 or coupled directly to the event server 130. The optional third party provider 140 may provide the particular item(s) to be made available by the event server 130 (e.g., for auction, raffle, selling, trading, etc.). In a further example, the optional third party provider 140 may provide reward points (e.g., Limbo points) given with every interaction by the communication device 110 with the event server 130. These reward points may be used to obtain free or lower cost (i.e., trading in reward points for a lower price) goods and services. The user may go to a physical store, website, or any provider and purchase goods and/or services in exchange for one or more of these reward points. In yet a further example, the reward points may be provided by the event server 130 and the third party provider 140 provides the free or lower cost goods and services.

While embodiments of the present invention have been discussed above with examples to auction games, the embodiments may also be practiced in non-auction games. For example, the event server 130 may host a bingo or sweepstakes in which the users play via their communication devices 110.

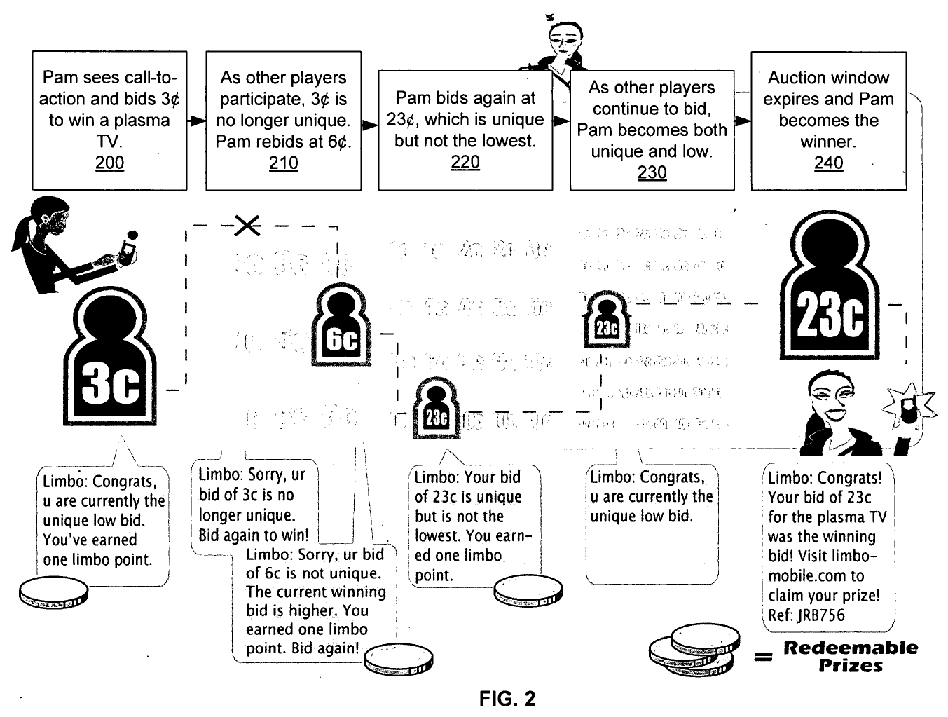

Reverse Auction—FIGS. 2-5

FIG. 2 is an illustration of how a user participates in a reverse auction embodiment of the invention. In step 200, Pam, a user, sees a call-to-action and bids 3¢ to win a plasma TV. The call-to-action may be any message or image that invites or encourages one or more users to participate in the reverse auction. In one example, the call-to-action is a message sent to any device capable of receiving the message. The device may be a cellular phone, computer, laptop, personal digital assistant, radio, television, or any other device capable of browsing the web and/or receiving a message to enter into the reverse auction. In one example, the call-to-action is an advertisement on a web site. The call-to-action may be any message or image that invites or encourages one or more users to participate in the reverse auction.

In the present example, Pam completes her bid of 3¢ on her cellular phone. Pam then receives a message on her cellular phone indicating the status of the bid as well as whether Pam has earned a point. In some embodiments, the message or words in the message may be shortened, abbreviated, and/or truncated to display information on a smaller screen of the digital device. In one example, the message may state, “Congrats, u are currently the unique low bid. You've earned one Limbo point.”

As other players participate, 3¢ may no longer be unique. As a result, Pam may receive a message on her cellular phone indicating that her bid is no longer unique. In one example, the message may state, “Sorry, ur bid of 003 is no longer unique. Bid again to win!”

In step 210, Pam re-bids at 6¢ after finding out that her original bid is no longer unique. Although a user is not required to bid multiple times in a reverse auction, if the user's bid is not the lowest unique bid, the user no longer has a chance to win the auction. Upon Pam's re-bid of 6¢, Pam may receive another message indicating that 6¢ is not unique as well as any other information that may encourage her to bid again. In one example, the message may state, “Sorry, ur bid of 6¢ is not unique. The current winning bid is higher. You earned one Limbo point. Bid again.”

In step 220, Pam bids again at 23¢ which is unique but not the lowest. As a result, Pam may receive a message indicating that 23¢ is not the lowest bid. In one example, the message may state, “Your bid of 23¢ is unique but is not the lowest. You earned one Limbo point.”

In step 230, as other players continue to bid, Pam's bid becomes both unique and low. Pam may receive a message indicating that Pam's bid of 23¢ is now the unique lowest bid. In one example, the message may state, “Congrats. U are currently the unique low bid.” In this example, Pam's bid is unique but not low. As others bid, another user may choose to bid the same amount as the lowest unique bid. As a result, that bid is no longer unique, and, therefore, the next lowest unique bid may win the reverse auction.

In step 240, the auction window expires and Pam becomes the winner. In various embodiments, the reverse auction ends after a predetermined time, when a predetermined currency is bid, or when a predetermined number of bids is reached. Once the end of the reverse auction is reached, the winner may receive a message indicating that they have won the auction and any other information associated with receiving the prize. In one example, the message may state, “Congrats! Your bid of 23¢ for the plasma TV was the winning bid! Visit limbo-mobile.com to claim your prize! Ref. JRB756.”

FIG. 3 is an illustration of exemplary messages transmitted to a cellular phone of a user participating in a reverse auction in an exemplary implementation of the invention. In other embodiments, the messages are transmitted to any communication device associated with the bidder.

In step 300, the cellular phone receives a message that a bid is not unique. In one example, a user may place a bid for a reverse auction that is not unique. As a result, the user may receive a message on the user's cellular phone indicating that the bid is not unique. The message may be sent to the user within seconds or minutes of the user's submission of the non-unique bid. In other embodiments, the message may be sent at any time either before or after the reverse auction is terminated.

In step 310, the cellular phone receives a message indicating tips. A tip is any information that may act as guidance or hints to users. For example, a tip may read, “There are lower unique bids.” or “The lowest unique bid is higher.” In other examples, the tip indicates a strategy for the user. In one example, the tip states the percentage of people who bid 1¢ in the last four reverse auctions.

In step 320, the cellular phone receives a message indicating that the user has been outbid. For example, the user may have the lowest unique bid of 3¢ until someone else also bids 3¢. The user may then receive a message indicating that the user has been outbid. If the user wishes to win the auction, the user must make a new bid greater than 30.

In step 330, the cellular phone receives a message regarding closing announcements. In some examples, the message states that the auction has come to an end or provide an amount of time left before the end of the auction. The message may also announce the winner of the auction or indicate instructions on receiving a prize.

In step 340, the cellular phone receives a message regarding a new auction. This message may encourage or invite users to bid on the new auction. In other embodiments, the event server 130 (FIG. 1) determines the auctions that the user is most likely to be interested in based on the user's participation within previous auctions. For example, if the user consistently bids in auctions where the prize is an IPOD™, the event server 130 may send a message regarding a new auction of an IPOD™ to the user.

Although the steps in FIG. 3 are sequential, the messages referred to within the steps may come in any order or at any time after the first bid is placed.

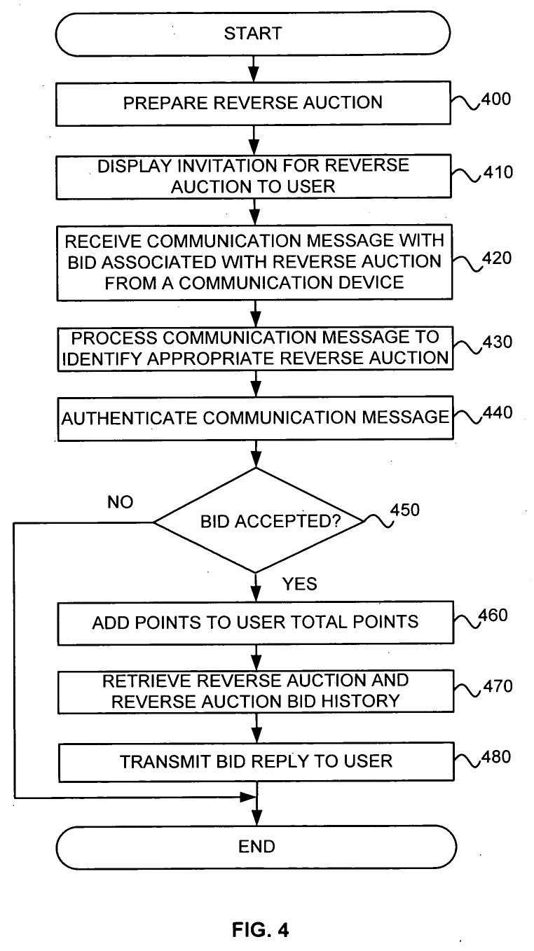

FIG. 4 is a flowchart for conducting a reverse auction in an exemplary implementation of the invention. In step 400, the event server 130 (FIG. 1) prepares the reverse auction. In preparing for a reverse auction, an event provider identifies the product for the reverse auction and sets up terms and conditions for the auction. Once the prize is identified, the reverse auction may be initiated. In addition to the identification of the prize, the event provider may take possession of the prize, license the prize, or enter into an agreement with a third party to provide one or more prizes to the winner of the reverse auction.

In step 410, the event server 130 displays an invitation for the reverse auction to a user. In some embodiments, the invitation can be a link, image, or icon on a website that identifies the reverse auction. The user may be encouraged or invited to bid on a particular prize within the reverse auction. In other embodiments, messages inviting users or advertising one or more reverse auctions can be transmitted over the radio, to the user's cell phone, personal digital device, computer, laptop, or any other communication device 110 (FIG. 1). Alternatively, a user may, on their own accord, go to an auction site on the Internet, and search for an auction for a particular product of interest.

In step 420, the event server 130 receives a communication message with a bid associated with the reverse auction from a communication device 110. Any communication device 110 may send the communication message to the event server 130. In one example, the user sends the communication message from a website to the event server 130. One example of the communication message comprises elements including a user identification, a specific auction, and a bid for the specific auction. In some embodiments, the communication message also comprises a payment for the bid. For example, the user may include a credit card number, which is charged one dollar in return for the option to place a bid in a specific reverse auction.

In step 430, the event server 130 processes the communication message to identify the appropriate reverse auction. The event server 130 may confirm that the particular reverse auction identified in the communication message is a reverse auction that has not ended. In some embodiments, a plurality of reverse auctions are conducted concurrently. The communication message may comprise both a bid and identification of a particular auction item or prize. If the user wishes to bid in multiple auctions, the user may send multiple communication messages, one for each bid. In other embodiments, the user may send a single communication message to bid on multiple auctions.

In step 440, the event server 130 authenticates the communication message. Each message may identify the user who bids, a payment for the option to bid, and a particular reverse auction. The event server 130 can confirm and/or verify the user identified in the communication message, the payment for the option to bid, and the particular reverse auction.

In one example, the event server 130 verifies a user identified in the communication message. If the user has an existing account with the event provider of the reverse auction, the user can include a password or other information to confirm that the user identified in the communication message is the same user identified in the account. In some embodiments, if the user does not have an account, the event server 130 can initiate and create an account or record to track the bids made by the user to the reverse auction. For example, a user may transmit their name and drivers license number to the event server 130. The event server 130 can then create the account associating the user's name with the driver's license.

The communication message may include a payment to bid in the reverse auction. In one example, the user includes a credit card number from which payment may be obtained. The event server 130 can confirm and/or charge a fee from a credit card in exchange for the option to bid in the reverse auction. The user may pay for the option to bid in any number of ways.

The communication message may also identify a particular reverse auction. The event server 130 may confirm that the particular reverse auction identified in the communication message is an actual reverse auction that has not ended. If the particular reverse auction identified in the communication message does not exist or has already ended, the event server 130 may send a message to the user requesting that the user select another reverse auction.

In step 450, the event server 130 determines if the bid is accepted or rejected. If the event server 130 cannot verify the user, then the event server 130 may reject the bid. In other embodiments, if the payment is included in the communication message and the payment is insufficient or cannot be charged, then the event server 130 may also reject the bid. If the event server 130 rejects the bid, the process of FIG. 4 ends.

In step 460, the event server 130 adds points to the user's total points. For each bid the user makes, the user may receive one or more points. In some embodiments, the event server 130 displays a user interface for the event provider to customize the awarding of points such as how many points are awarded for bids. The event server 130 can create accounts to track the user's bids and/or user's total points. For example, the event server 130 may use an account for one reverse auction to track each individual user, associate each point with a user, and associate each bid with a user. In another example, the event server 130 may establish one or more separate accounts for each user.

In further some embodiments, points may be awarded for activities other than placing a bid. For example, points may be awarded for bidding a lucky number, being the Nth bid made, being the Nth bidder, being the Nth new member, or collecting N reward points.

In step 470, the event server 130 retrieves the reverse auction and the reverse auction bid history. A reverse auction bid history is a log of all bids and associated users for one or more particular reverse auctions. In one example, the user bids within a particular reverse auction for an Apple Ipod™. If the bid is accepted, the particular reverse auction and the particular reverse auction bid history is retrieved from a storage (e.g., storage within the event server 130) and the new bid is logged.

In step 480, the event server 130 transmits a bid reply to the user. The bid reply can inform the user that the user's bid is the lowest unique bid, the bid is not unique, the bid is unique but is not the lowest, or any other message. The bid replay may include any message previously identified in FIG. 2 or 3.

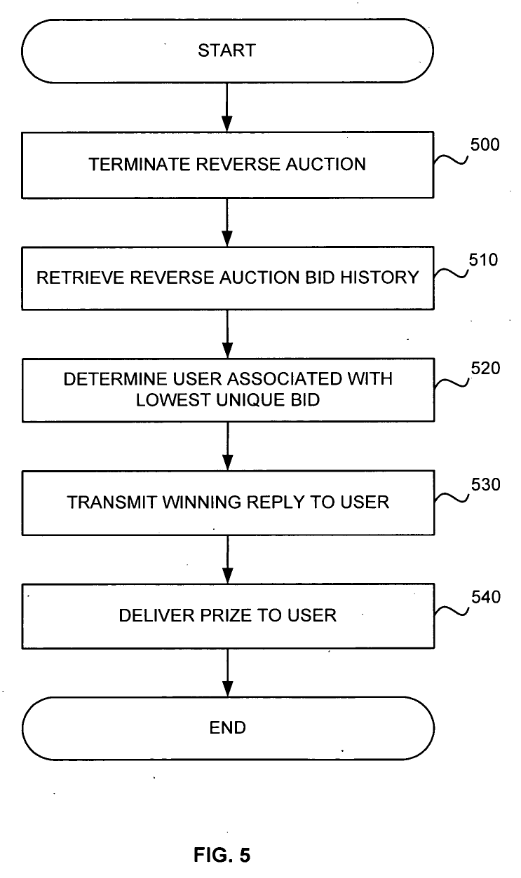

FIG. 5 is a flowchart depicting an exemplary method for concluding a reverse auction. In step 500, a predetermined event may conclude a particular reverse auction. The predetermined event may comprise the termination of a predetermined period of time, receiving a predetermined number of bids, receiving bids from a predetermined number of users, receiving a predetermined bid, or any other measure.

In step 510, the event server 130 retrieves the reverse auction bid history. In some embodiments, one or more reverse auction bid histories for a particular reverse auction is retrieved from a cache or other storage medium located on a server or communication device. Once the reverse auction bid history is retrieved, the event server 130 determines the user associated with the lowest unique bid in step 520.

The user with the lowest unique bid after the reverse auction has concluded may be the winner of the reverse auction. In other embodiments, the winner of the reverse auction may be a second lowest unique bid after the reverse auction has concluded. The event server 130 may determine the winner in any number of methods.

In step 530, the event server 130 transmits a winning reply to the user. The user may receive the winning reply over any communications device. The winning reply may alert the user that they have won the reverse auction and further instruct the user how to receive the prize. The winning reply may also include advertisements for additional reverse auctions. The event server 130 may also send e-mails to the other bidders notifying them that their bid was unsuccessful and providing an update total of their points.

In step 540, the prize is delivered to the user. In other embodiments, the user may claim the prize directly. For example, the user may receive a password which enables the user to receive or download songs or media. The user may also receive prizes by mail or delivery. The user may also physically appear at an appropriate location to receive the prize. The user may receive the prize in any number of methods.

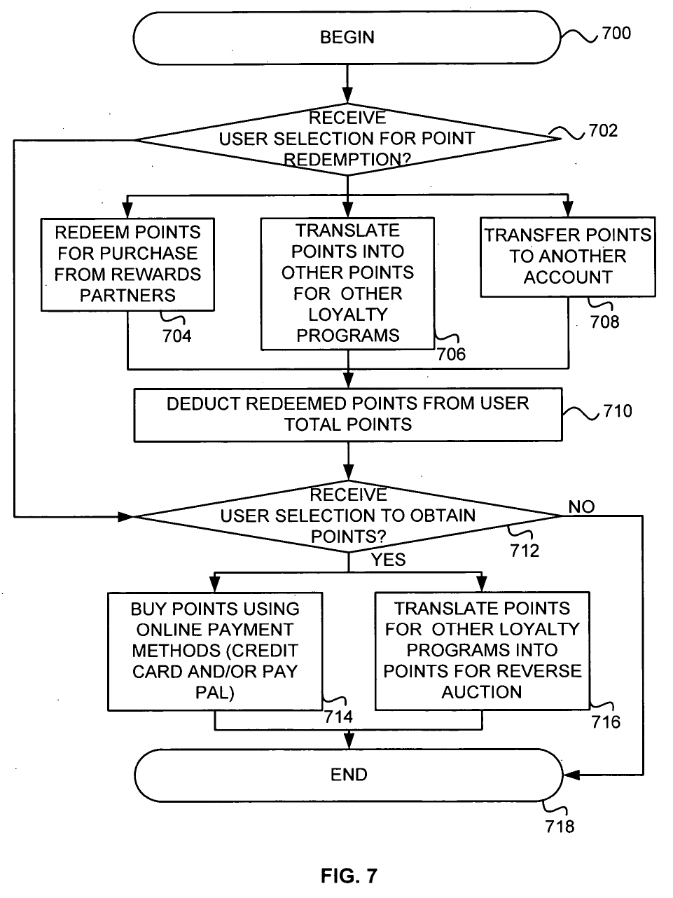

Points With a Network Event—FIGS. 6-7

A system for using points in a network event includes a communications interface and a processor. In one embodiment, the communication interface receives a message indicating an entry or bid from a user for a network event. The processor processes the message to determine whether to accept the entry for the network event. The processor then accumulates at least one point for the entry into a point total for the user in response to accepting the entry. In some embodiments, points may also be awarded for activities other than placing a bid. For example, points may be awarded for playing a lucky number, being the Nth entry made, being the Nth player, being the Nth new member, or collecting N reward points.

Points are any number or unit used to keep track of value accumulated by a user. The points can advantageously be used to develop loyalty to the network event provider and to increase motivation for a user to submit more entry for the network event, such as a reverse auction. Since the points can be redeemed into rewards such as products or travel certificates, the points encourage repeat behavior of the users to accumulate more points by playing more. Furthermore, the points return some value to the user submitting the entry regardless of whether the entry results in a win in the network event.

FIGS. 6 and 7 depict one example of using points in network events such as contests and games. FIG. 6 depicts a flowchart for using points in an exemplary implementation of the invention. FIG. 6 depicts some basic functions for points management such as displaying point information, deleting an account, and forfeiting points.

FIG. 6 begins in step 600. In step 602, the event server 130 registers or logs in the user based on user information such as a user ID/phone number and password. If the user is not registered, the event server 130 can register the user if the user provides personal information such as an accurate name, address, e-mail address, wireless phone number, and age. In step 604, the event server 130 checks whether a user selection to display the point information is received. The user may select with a mouse or pointer any of the point information related to their account. If the user selection to display the point information is not received, the process proceeds to step 614.

If the user selection is received, the event server 130 proceeds to one of the steps 606-612 based on the user selection. Steps 606-612 relate to different types of point information that can be displayed. In order to display the point information, the event server 130 may retrieve the point information stored in an account in a database of user records. Some examples information contained in an account includes the unique ID (i.e. login name or phone number), password, and total number of points for the user.

In step 606, the event server 130 displays the point activity to show a history of credit or debits of points for the user's account. In step 608, the event server 130 displays the points account for the user such as the balance of points available. In step 610, the event server 130 displays the recent redemption activity for redeeming or converting points. In step 612, the event server 130 displays the reward activity for the user's account.

In step 614, the event server 130 checks whether a user selection to cancel the account is received. In one example, the user selection is in the form of an SMS message, which includes the text “credits cancel.” If no user selection to cancel the account is received, the process continues to step 620. If a user selection to cancel the account is received, the event server 130 cancels the account in step 616. In step 618, the event server 130 also deletes the points associated with the account.

Some networked event or game providers may want to limit the points by lifespans, expiration times, or user inactivity. These limitations may be variably set by an event or game manager or points manager. In one example, if the user has not participated in a game for a period of 12 months, the event server 130 forfeits the points in the user's account.

In step 620, the event server 130 determines the period of user inactivity for the user's account. In step 622, the event server 130 checks whether the user inactivity period exceeds the allowed inactivity period. If the user inactivity is below the allowed inactivity, the process ends in step 626. If the user inactivity is above the allowed inactivity period, the event server 130 forfeits the points for the user's account in step 624. FIG. 6 ends in step 626.

FIG. 7 depicts a flowchart for redeeming and obtaining points in an exemplary implementation of the invention. The points may be redeemed to purchase goods, services, or discounts. Some examples of goods that can be purchased by points are ringtones, wallpapers, games, subscriptions (i.e. mobile service, satellite radio, Netflix, Blockbuster, newspaper, and magazine), and other type of consumer products.

The network event or game provider may partner or agree with another goods or service provider to offer additional goods and services. Some examples of the goods and/or service provider are in the retail and travel industry. Partnering with other goods and/or service providers may create access to and marketing exposure to a large number of consumers, who may participate in a reverse auction. Also, the website of the networked event or game provider may act as a storefront for the goods and/or service providers to sell and market their goods and/or services. Also, the event or game provider may keep track of redemption of points to provide marketing information for the goods and/or service providers.

The points may also be exchanged for other loyalty programs of goods and/or service providers such as frequent flier miles from airlines. The points may also be exchanged for coupons, discounts, and vouchers for future purchases of goods and/or services. Points may also be redeemed to obtain more plays in the game or to make a charitable donation.

Points are, in one embodiment, accumulated when a user submits an entry to play a contest, game, or sweepstakes. However, in some cases, a user may want to redeem their points but has insufficient points in their balance for the purchase or exchange. The user can then purchase more points by using a credit card or an on-line payment method such as PayPal. In some embodiments, the event server 130 may allow a user to combine their point totals with other users into groups to aggregate their points for redemption.

In exemplary embodiments, a value of one point is greater than or equal to the cost to enter the network event. In on example, a user places a bid with a cellular telephone and is subsequently charged $1.00 (e.g., via reverse SMS). In return, the user enters into a reverse auction and receives one point. The single point may have a value equal to or greater than $1.00 because the single point may be redeemed for a prize or product worth $1.00 or more (e.g., a ringtone valued at $1.00.) In other examples, multiple points may be redeemed for one or more prizes or products. In other embodiments, the single point may be redeemed for a prize or product worth less than the cost to enter the network event.

FIG. 7 begins in step 700. In step 702, the event server 130 checks whether the user selection for point redemption is received. If no user selection for point redemption is received, the process proceeds to step 712. If a user selection for point redemption is received, the event server 130 proceeds to one of steps 704-708 for different options in redeeming points.

In step 704, the event server 130 redeems points for purchase of goods and/or services from rewards partners. Prior to the redemption, the event server 130 may display a complete shopping experience to the user to assist in redeeming their points. For example, the event server 130 can display ten items that the user can purchase with their points. Items can be highlighted if the user can afford the items based on their points available. The event server 130 may also display a list of reward partners that the user can redeem their points for. The event server 130 may display rewards partners or items based on the profile in the user's account and total number of points available. The items can be shown in the amount of point needed to purchase and in the amount of real money needed.

In step 706, the event server 130 translates the points into other points for other loyalty programs. In step 708, the event server 130 transfers the points to another account. In step 710, the event server 130 deducts the points redeemed from the user's total points in their account. After the redemption, the event server 130 may display or e-mail the new account balance of points.

In step 712, the event server 130 checks whether the user selection for obtaining points has been received. If no user selection for obtaining points has been received, the process ends in step 718. If the user selection for obtaining points has been received, the event server 130 proceeds to step 714 or step 716 depending on the user selection of how the user wants to obtain points. In step 714, the event server 130 buys points using an online payment such as PayPal or a credit card from the user. Payment can also be made by Premium SMS services for mobile phones. In step 716, the event server 130 translates points for other loyalty programs into points for the user account. FIG. 7 ends in step 718.

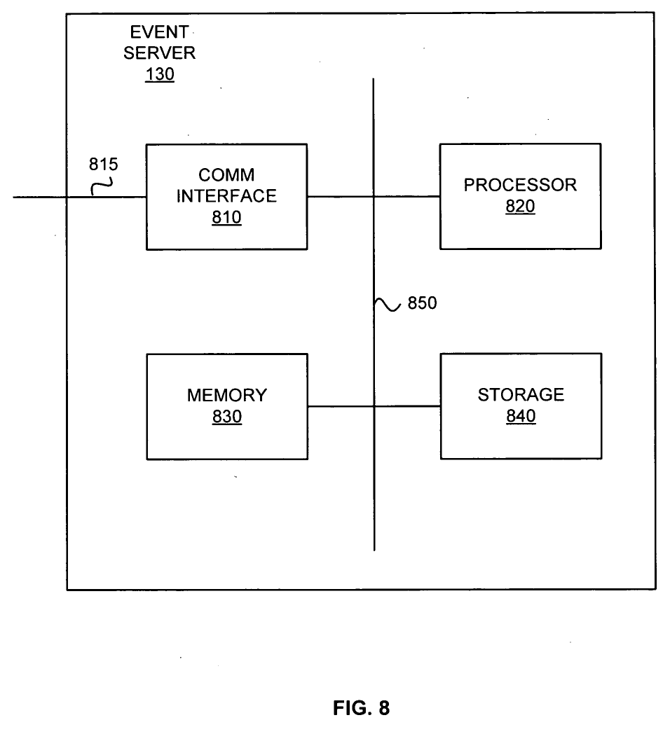

FIG. 8 is a block diagram of the event server 130 in an exemplary implementation of the invention. The event server 130 includes a communications interface 810, a processor 820, a memory 830, and storage 840, which are all coupled to the bus 850. Bus 850 provides communications between the communications interface 810, the processor 820, the memory 830, and the storage 840.

The processor 820 executes instructions. The memory 830 permanently or temporarily store data. Some examples of the memory 830 are RAM and ROM. The storage 840 also permanently or temporarily store data. Some example of the storage 840 are hard disks and disk drives.

The communications interface 810 communicates over the network 120 with the communication devices 110 (see FIG. 1). FIG. 8 depicts one example of how the event server 130 can be configured. There are numerous variations in which the event server 130 can be configured.

The embodiments discussed herein are illustrative of one example of the present invention. As these embodiments of the present invention are described with reference to illustrations, various modifications or adaptations of the methods and/or specific structures described may become apparent to those skilled in the art: All such modifications, adaptations, or variations that rely upon the teachings of the present invention, and through which these teachings have advanced the art, are considered to be within the scope of the present invention. Hence, these descriptions and drawings should not be considered in a limiting sense, as it is understood that the present invention is in no way limited to only the embodiments illustrated.

The above-described functions can be comprised of instructions that are stored on storage media. The instructions can be retrieved and executed by a processor. Some examples of instructions are software, program code, and firmware. Some examples of storage media are memory devices, tape, disks, integrated circuits, and servers. The instructions are operational when executed by the processor to direct the processor to operate in accord with the invention. Those skilled in the art are familiar with instructions, processor(s), and storage media.

What is claimed is:

1. A system for using points in a network event, the system comprising:
a communication interface configured to receive a message indicating an entry from a user for the network event; and
a processor configured to process the message to determine whether to accept the entry for the network event and accumulate at least one point for the entry into a point total for the user in response to accepting the entry.

2. The system of claim 1 wherein the network event comprises a reverse auction.

3. The system of claim 1 wherein the network event comprises a sweepstakes.

4. The system of claim 1 wherein the network event comprises a contest.

5. The system of claim 1 wherein the processor is further configured to redeem some of the point total for a product.

6. The system of claim 1 wherein the processor is further configured to redeem some of the point total for a service.

7. The system of claim 1 wherein the processor is further configured to redeem some of the point total for a discount.

8. The system of claim 1 wherein the processor is further configured to exchange some of the point total for value of a loyalty program.

9. The system of claim 1 wherein the processor is further configured to receive payment from the user and add additional points to the point total based on the payment.

10. The system of claim 1 wherein the processor is further configured to display point information for the user.

11. The system of claim 10 wherein the point information comprises the point total.

12. The system of claim 10 wherein the processor is further configured to retrieve the point information for the user from a database.

13. The system of claim 1 wherein the processor is further configured to forfeit the point total after a period of user inactivity.

14. The system of claim 1 wherein the at least one point is redeemable for a product.

15. The system of claim 1 wherein a value of at least one point is greater than a cost to enter the network event.

16. The system of claim 1 wherein a value of at least one point is equal to a cost to enter the network event.

17. A method for using points in a network event, the method comprising:
receiving a message indicating an entry associated with the network event from a user;
processing the message to determine whether to accept the entry for the network event; and
accumulating at least one point for the entry into a point total for the user in response to accepting the entry.

18. The method of claim. 17 wherein the network event comprises a reverse auction.

19. The method of claim 17 wherein the network event comprises a sweepstakes.

20. The method of claim 17 wherein the network event comprises a contest.

21. The method of claim 17 further comprising redeeming at least some of the point total for a product.

22. The method of claim 17 further comprising redeeming at least some of the point total for a service.

23. The method of claim 17 further comprising redeeming at least some of the point total for a discount.

24. The method of claim 17 further comprising exchanging at least some of the point total for value of a loyalty program.

25. The method of claim 17 further comprising:
receiving payment from the user; and
adding additional points to the point total based on the payment.

26. The method of claim 17 further comprising displaying point information for the user.

27. The method of claim 26 wherein the point information comprises the point total.

28. The method of claim 26 further comprising retrieving the point information for the user from a database.

29. The method of claim 26 further comprising forfeiting the point total after a period of user inactivity.

30. The method of claim 17 wherein the at least one point is redeemable for a product.

31. The method of claim 17 wherein a value of at least one point is greater than a cost to enter the network event.

32. The method of claim 17 wherein a value of at least one point is equal to a cost to enter the network event.

33. A software product for using points in a network event, the software product comprising:
server software operational when executed by a processor to direct the processor to receive a message indicating an entry from a user for the network event, process the message to determine whether to accept the entry for the network event, and accumulate at least one point for the entry into a point total for the user in response to accepting the entry; and
a storage medium configured to store the server software.

34. The software product of claim 33 wherein the network event comprises a reverse auction.

35. The software product of claim 33 wherein the network event comprises a sweepstakes.

36. The software product of claim 33 wherein the network event comprises a contest.

37. The software product of claim 33 wherein a value of at least one point is greater than a cost to enter the network event.

38. The software product of claim 33 wherein a value of at least one point is equal to a cost to enter the network event.
